(19) United States
(12) Patent Application Publication
(10) Pub. No.: US 2005/0232690 A1
(43) Pub. Date: Oct. 20, 2005

(54) Binder for sheets or cards

(76) Inventor: Alessandro Ledda, Nerviano (IT)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/514,680

(22) PCT Filed: Jun. 4, 2003
(86) PCT No.: PCT/IT03/00351

§ 371 Date: Nov. 16, 2004

(30) Foreign Application Priority Data
Jun. 6, 2002 (IT) MI2002 A 001235

(51) Int. Cl. B42F 3/00

(52) U.S. Cl. 402/58

(57) ABSTRACT

The present invention relates to a binder for sheets or cards comprising a spine member provided with one or more longitudinal recesses, having a substantially circular cross-section. In each recess there is inserted at least one support having substantially circular cross-section and provided with means for fixing at least one external sheet of the binder, and at least one of said recesses has an opening suitable for allowing rotation inside it of support and of the external sheet fixed thereto. Said spine member is provided in the central zone with a fastener for said sheets or cards and/or at least one holder for said fastener.

### FIELD OF INVENTION

The present invention relates to a binder for sheets or cards of paper, cardboard or plastics, which can be used in particular for collecting and holding together the pages of a menu.

### BACKGROUND

Binders are known in the art, formed of a rectangular sheet of plastics material, provided in the central zone of two parallel groovings which enable folding of the sheet in three portions. A fastener for the sheets, for example a spring or ring element, is fixed in the portion between said two groovings, which forms the so-called “spine” of the binder.

Said binders have the advantage of being easily cleanable, which makes them particularly suitable for the use as menu covers for restaurants or bars, and in addition they have a low production cost.

However, a disadvantage of the known binders consists in that if the plastic material of which they are made is hard, for example polypropylene, the binder tends to maintain the conformation which has been impressed. For instance, after the grooving, the binder tends to close itself if it is laid open and therefore is disadvantageous in the use. If on the contrary the plastic material of which the binder is made is less hard, for example it is made of polyvinylchloride, the binder breaks itself easily along the grooving lines.

FR-A-2795020 discloses a binder comprising a spine member and two cover pages which are provided, at the edge thereof, with a protruding axis with a plurality of collets which divide the axis in a plurality of segments. These segments are received in a plurality of housings having a C-profile, made in the spine member.

However, the disadvantage of this binder is that it must be necessarily produced by means of a very expensive injection moulding process.

### SUMMARY

Object of the present invention is therefore providing a binder for sheets or cards which is free from the above mentioned drawbacks. Said object is obtained by means of a binder whose main features are specified in the first claim and other features are specified in the following claims.

A first advantage of the binder according to the present invention consists in its convenient use, as a matter of fact it does not have the tendency to close itself when it is laid open. Further, it can be made of any material, for example a hard and cleanable material, and therefore is suitable for any kind of use. In particular, it can be used as a cover for a menu.

Further advantages and features of the binder according to the present invention will appear to those skilled in the art from the following detailed description of some embodiments thereof with reference to the accompanying drawings wherein.

### BRIEF DESCRIPTION OF THE DRAWING(S)

FIG. 1 shows a perspective partial view of the binder according to a first embodiment;

FIG. 2 shows a cross-sectioned view of the binder of FIG. 1;

FIG. 3 shows a partial perspective view of a binder according to an alternative embodiment of the invention; and

FIG. 3a shows a cross-sectioned view of a detail of FIG. 3.

### DETAILED DESCRIPTION OF THE PREFERRED EMBODIMENT(S)

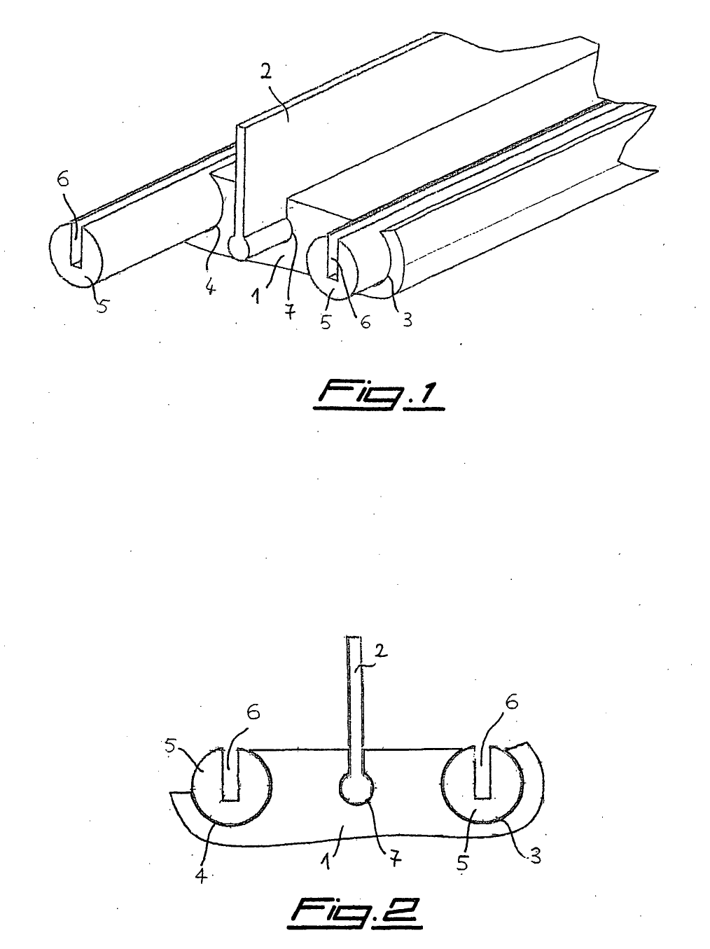

With reference to FIG. 1, there is shown that the binder for sheets of cards according to the present embodiment of the invention comprises a spine member 1 made of a hard material, for example polypropylene plastics.

Said member 1 is provided, at the longitudinal edges thereof, of one or more recesses having cross-section of substantially circular shape. According to a preferred embodiment of the invention, shown in the figures, said recesses made in the spine member are two, longitudinal and parallel to each other, indicated in the Figure with numbers 3 and 4.

Each recess is suitable for receiving and holding inside a support 5 for a sheet of plastics, paperboard or other preferably hard material having the function of cover for the sheets or cards inserted in the binder. Each support 5 has a circular cross-section of slightly smaller area than that of the cross-section of the corresponding recess 3 or 4, and is therefore free to rotate inside it.

Supports 5 may in particular have the shape of a small cylinder, preferably having the same length of the same recess, as shown in FIG. 1.

Alternatively, each support 5 can be made of two or more spheres, lined up with each other, having a cross-section of slightly smaller area than that of the corresponding recess, which are fixed to the same sheet in plastics, cardboard or other material having the function of cover.

Thus, said cover sheet is rotatably connected to spine member 1. To this purpose, each support 5 is provided with means for fixing said external sheet in plastics, cardboard or other material.

In the embodiment of the invention which is presently shown, said means for fixing are formed of a cutting 6 longitudinally made on the lateral wall of each cylinder or other support 5. A side of an external sheet of the binder can be inserted and fixed inside cutting 6. However, in other embodiments of the invention the fixing of said external sheets of the binder to supports 5 can be carried out differently; a further possibility is that supports 5 and said external sheets are made in one piece.

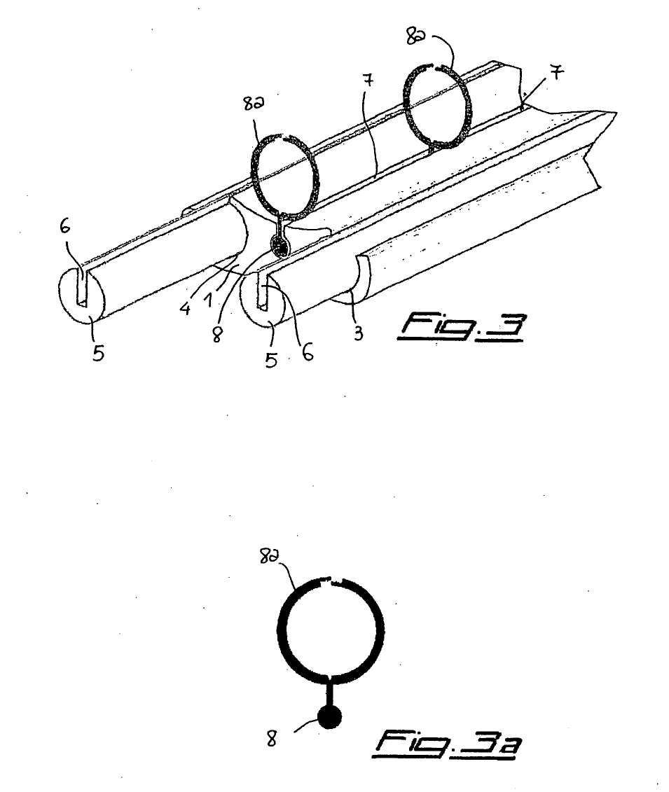

As shown in FIG. 2, in order to allow opening of the binder, at least one of the supports 5 must be free of rotating of at least 90° inside the corresponding recess 4 even when it is fixed to an external sheet. To this purpose, said recess 4 is provided with an opening sufficiently wide for allowing said rotation, preferably of at least 120°.

Advantageously, in the present embodiment of the invention also the other support 5 whereto the external sheet is fixed is free of rotating at least partially inside the corresponding recess 3 even when it is fixed to an external sheet, as shown in the figure.

In an alternative embodiment of the present invention, one of the two external sheets in hard material is not connected to said spine member 1 by means of a support 5, but it is directly welded on one side of the spine member 1. In this case, in said member 1 is made a single recess for the insertion of the cylinder corresponding to the second external sheet, which forms the front page of the binder.

Referring back to page 1, there is shown that a holder 2 of a fastener of any known type (not shown in the figure), for example an element with rings, spring or clip can be fixed in the central zone of said spine member 1. Said holder 2 can be for example made of a rectangular member provided with a relief at one longitudinal edge thereof. Said relief is suitable for being inserted in an apposite groove 7 made in the spine member 1, as shown in the figure.

In an alternative embodiment of the invention, holder 2 could be directly welded to member 1 or said holder 2 and said spine member 1 could be made in one piece.

In a further embodiment of the invention, shown in FIG. 3, a multiplicity of holders 8 having cylindrical or spherical shape could be inserted in groove 7, a ring fastener 8a being fixed to each of said holders. In this way, the number of fasteners of the binder can be determined according to the needs of the final user and possibly changed at the moment of use. Holders 8 and fastener 8a can advantageously be made by moulding in one piece, such as the one shown in FIG. 3a.

By means of the application of a plate, not shown in the figure, at the two ends of spine member 1, it can be prevented that supports 5 come out from recesses 3 and 4 and optionally that holder 2 or holders 8 come out from the relevant groove.

Possible variations and additions can be made by those skilled in the art to the embodiment here described and shown by remaining within the scope of the invention. For example, besides recesses 3 and/or 4, further longitudinal recesses can be made in spine member 1, for inserting corresponding holders and sheets of hard material in function of internal dividers between different sections of the binder.

In addition, the fastener for the sheets or cards can be directly fixed to the central portion of the spine member 1, without using a holder 2 or 8.

1. Binder for sheets or cards comprising a spine member provided in the central zone of a fastener for said sheets or cards and/or at least one holder for said fastener, characterized in that said spine member is provided with one or more longitudinal recesses, having a substantially circular cross-section, in each recess being inserted a support having substantially circular cross-section which is provided with means for fixing at least one cover of the binder, said means being formed of a cutting longitudinally made on the lateral wall of each support inside which a side of said cover of the binder can be inserted and fixed, at least one of said recesses having an opening suitable for allowing rotation inside it of the support and of the cover fixed thereto.

2. Binder according to claim 1, characterized in that said support has cylindrical shape.

3. Binder according to claim 1, characterized in that said support is formed of two or more spheres lined up with each other.

4. Binder according to claim 1, characterized in that the opening of at least one recess is suitable for allowing a rotation of at least 90° of the support inserted in said recess and of the cover thereto fixed.

5. Binder according to claim 4, characterized in that said rotation is of at least 120°.

6. Binder according to claim 1, characterized in that said recesses are at least two.

7. Binder according to claim 1, characterized in that said holder is formed of an element having substantially rectangular shape, one edge of which is provided with a relief suitable for being inserted in a apposite groove made in the spine member.

8. Binder according to claim 1, characterized in that it is provided with a multiplicity of holders for fasteners, each holder being formed of a member having cylindrical or spherical shape suitable for being inserted in a apposite groove made in the spine member.

9. Binder according to claim 1, characterized in that at the two ends of the spine member is applied a plate suitable for preventing said support and/or said holders to come out.

10. Binder according to claim 1, characterized in that said spine member, said holders and/or said covers are made in hard plastics material.
